(19) United States
(12) Patent Application Publication
(10) Pub. No.: US 2011/0256511 A1
(43) Pub. Date: Oct. 20, 2011

(54) TACTICAL MISSION PLANNING SET

(76) Inventor: James William Victor Cragg, Carson, CA (US)

(21) Appl. No.: 12/760,492

(22) Filed: Apr. 14, 2010

(51) Int. Cl. G09B 19/00

(52) U.S. Cl. 434/11

(57) ABSTRACT

The present invention provides a tactical mission planning kit, comprising a tile set including a plurality of tiles, a board for placement of the tiles, a set of markers for drawing on the board, and a compact carrying case comprising a housing for the tile set, board and set of markers.

### FIELD OF THE INVENTION

The present invention relates to tactical symbology, and more particularly, some embodiments relate to a tactical mission planning set.

### DESCRIPTION OF THE RELATED ART

The planning environment for tactical missions, whether in the military or in law enforcement, can be extremely stressful, both for the leader who is trying to impart direction, and for the follower who is trying to understand. The tools and equipment on hand to outline the mission instructions may not be clear or universal for all organizations. The modem operational environment is a rapidly evolving playing field and our troops and servicemen deserve a symbology and planning system that is clear, thorough, and adaptable. Additional benefits would include an enhanced understanding of mission planning graphics at lower levels of leadership.

Military tactical level leaders conduct mission planning, training, and after action reviews using home-made solutions such as index cards and plastic toy Army men. There is no universal symbol system in use. In addition, such systems are incomplete and rarely used at the squad or platoon level except in sector sketch cards. In the urban battle environment encountered in the counter-insurgency operations common to the Global War on Terrorism (GWOT), clear communication and universal understanding is a requirement for successful operations.

Identification of equipment is haphazard in law enforcement and military environments. Backpacks, cases, and boxes may look alike, and inter jurisdictional or international or inter-unit symbols are lacking. NATO forces speak multiple languages, yet a red cross denoting medical supplies seems to be the only symbol recognized across the lines as a distinction between groups. For larger units and some smaller units, there are an array of solutions that can be mind boggling and dazzling in their creativity and complexity. Military Intelligence personnel can spend months mastering military map symbology.

The United Nations Military Symbols Handbook offers operational graphics and colors as well as symbols peculiar to peacekeeping to identify actions, places, personnel, and institutions. The U.S. Army Field Manual 101-5-1/Marine Corps Reference Publication No. 5-2A is the publication used to cover operational terms and graphics. These references cover symbology for hundreds of units, equipment, actions, enemy units, and stability and support operations.

The purpose of the FM 101-5-1 is explained as such:
“This manual sets forth doctrine for the United States Army and the United States Marine Corps in the use of land-based warfighting symbology. The manual is a dictionary of operational terms and military graphics. It is designed for commanders and staffs from company through corps to communicate instructions to subordinate units.
This manual describes symbols for use in the force domain (maneuver command and control) but does not supersede the military standards which describe symbols for use in the engagement domain (“radar” tracking, evaluation, engagement, or engagement system directing). Military standards established for air defense engagement and systems control and aircraft “heads up” displays are to be used. When information is transferred from an engagement domain system to force domain command and control system, it will be automatically or manually converted to the force domain symbols in this publication.”

Military Standard 2525C is an ever evolving American document that in its entirety covers more than 1000 pages of specific circumstances, events, personnel, individual equipment, and other common warfighting symbology. It is the sister document to NATO standard APP-6A, Military Symbols for Land Based Systems, that was designed to enhance interoperability and compatibility of NATO Land Component Command, Control, Communications, Computer and Intelligence (C41) systems, operations, and training. These symbols can be displayed on automated map displays and can be marked onto manual maps as well. However, due to the depth that these symbols cover, learning these symbols can take a huge amount of time and will not be known by everyone who sees them. So while there are many team and larger unit symbols, there are few possibilities other than what a small unit leader is able to cobble up on their own with their skills and available tools.

### BRIEF SUMMARY OF EMBODIMENTS OF THE INVENTION

The present invention is directed toward tactical symbology, which may be in the form of a tactical mission planning set. The simplicity of the symbols allows them to be easily taught and understood such that all parties involved in an operation know where they are supposed to be as well as those who will be around them. This solution is inexpensive, easy to use, requires minimal training, offers flexibility in rapidly changing operations, requires no power source, is rugged enough for repeated field use, and offers the commander/leader an overview of the operating environment. Since the tactical mission planning set was built for and designed primarily on the advice and guidance of operators on the ground, the success of tactical mission planning set is highly related to their commitment.

According to various embodiments of the invention, a tactical mission planning kit is provided comprising a tile set including a plurality of tiles, a board for placement of the tiles, a set of markers for drawing on the board, and a compact carrying case comprising a housing for the tile set, board and set of markers. In some embodiments, the tiles comprise magnetic tiles, the board comprises a flexible magnetized dry erase board, and the markers comprise dry erase markers. The flexible board may be configured to be rolled up and inserted into the carrying case along with the tiles and markers. The kit may further comprise a carrying bag for holding and facilitating the transport of the compact carrying case.

In operation, the flexible magnetized dry erase board is used to simulate a tactical mission by employing the magnetic tiles as tactical symbols, wherein each tile is marked with one or more symbols. The symbols designate friendly and enemy personnel according to equipment they carry and mission role. The symbols may be based on an arrow symbol that iconizes an automatic rifle. In some cases, the tiles and the board are provided in a subdued or camouflaged color for use in tactical environments.

In some embodiments, the plurality of tiles includes tiles representing a commander, a platoon leader, a squad leader, reconnaissance/intelligence, an automatic rifleman, a breacher, a sniper, a medic, a psychological operations operator/hostage negotiator, a grenadier, explosive ordnance disposal (EOD), a light machine gun, a medium machine gun, a mortar, an engineer, a canine handler, a police patrol officer/military policeman, a sniper, a driver, a rocket, hazardous materials (HAZMAT)/nuclear biological chemical warfare (NBC) technician, maintenance, supply, media, a dead person, a wounded person, a person, an aviator, a mariner/diver, a paramedic, a fireman. The plurality of tiles may further include one or more blank tile for selectively adding units. In one implementation, each tile is marked with one or more symbols based upon a universal set of symbols designed to be simple to allow for quick drawing with the fewest brush strokes.

Further embodiments of the invention are directed toward a system, comprising a tactical mission tile set including a plurality of tiles, wherein each tile is marked with one or more symbols, a board for placement of the tiles, and a set of markers for drawing on the board. The system may further comprise a compact carrying case comprising a housing for the tile set, board and set of markers, as well as a carrying bag for holding and facilitating the transport of the compact carrying case. In some cases, the tiles comprise magnetic tiles, the board comprises a flexible magnetized dry erase board, and the markers comprise dry erase markers. The flexible board is configured to be rolled up and inserted into the carrying case along with the tiles and markers.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates a tile set comprising a plurality of small tiles that are marked with symbols in accordance with the principles of the invention.

FIG. 2 illustrates a tactical mission planning kit in accordance with the principles of the invention.

FIG. 3 illustrates an example patch including a symbol in accordance with the principles of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward tactical symbology. In some embodiments, this tactical symbology is in the form of a tactical mission planning set. Such tactical symbology may provide an answer for the small unit commander on the ground. Whether one is involved in classroom training, a real life scenario, or after action review, a tactical mission planning set, such as described herein, brings a level of organization to various mission types that were previously difficult or impossible to achieve. The novelty of the tactical mission planning set lies in both the intellectual aspect of the symbols and the physical implementation of the symbols in training, operations and after action review.

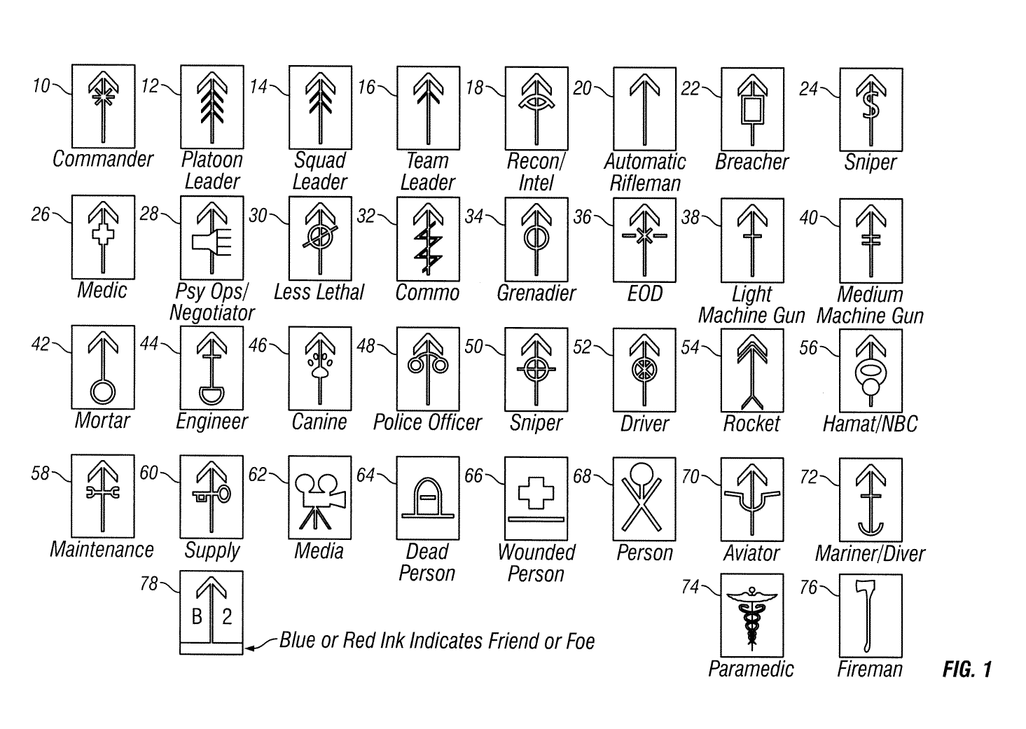

Referring to FIG. 1, in one embodiment of the invention, the tactical mission planning set includes a tile set comprising a plurality of small tiles 10-78 that are marked with symbols that designate friendly and enemy personnel according to the equipment they carry and mission role, as well as symbols for non-combatants and casualties. Specifically, tile 10 represents a commander, tile 12 represents a platoon leader, tile 16 represents a squad leader, tile 18 represents reconnaissance/surveillance/intelligence operator, tile 20 represents an automatic rifle, tile 22 represents a breacher, tile 24 represents a sniper, tile 26 represents a medic, tile 28 represents a psychological operations operator/hostage negotiator, tile 30 represents a less lethal system operator, tile 32 represents a communications systems operator, tile 34 represents a grenadier, tile 36 represents an explosive ordnance disposal (EOD) technician, tile 38 represents a light machine gun, tile 40 represents a medium machine gun, tile 42 represents a mortar, tile 44 represents an engineer, tile 46 represents a canine handler, tile 48 represents a police patrol officer/military policeman, tile 50 represents a sniper, tile 52 represents a driver, tile 54 represents a rocket, tile 56 represents hazmat/NBC, tile 58 represents maintenance, tile 60 represents supply, tile 62 represents media, tile 64 represents a dead person, tile 66 represents a wounded person, tile 68 represents a person, tile 70 represents an aviator, tile 72 represents a mariner/diver, tile 74 represents a paramedic, tile 76 represents a fireman, and tile 78 is a (previously) blank tile for selectively adding units. In some embodiments, the tiles 10-78 are magnetic for simple attachment and removal from a magnetic board.

The symbology system behind the illustrated tiles is based on an arrow symbol that iconizes a standard automatic rifle. These symbols cover most of the basic individual missions/jobs and equipment that may be found on a battlefield. As would be appreciated by those of ordinary skill in the art, although the more basic battlefield missions or jobs are covered in these symbols, more exotic or current missions or jobs are not included. Such symbols, however, may be included in the tactical mission planning set without departing from the scope of the invention. The symbology system/tiles of FIG. 1 builds on the current symbology (e.g., symbols 20, 24, 34, 38, 40, 42, 54) and incorporates explosive ordnance disposal (EOD), K-9 units, media, casualties, etc. In additional embodiments of the invention, the tactical mission planning set may further include symbols that encompass additional law enforcement personnel in a civilian environment.

Many of the symbols include the arrow symbolizing the automatic rifle as a base because, as doctrine states, every soldier is a rifleman first and can employ his rifle on the battlefield. The commander adds the star of the compass rose to the shaft denoting direction as part of leadership and command. The platoon leader has three chevrons on the shaft denoting leadership over squad and team leaders and platoon members. In general, chevrons denote leadership. The squad leader has two chevrons on the shaft denoting leadership over team leaders and squad members. The team leader has one chevron on the shaft denoting leadership over team members. The reconnaissance/surveillance/intelligence operator is symbolized by an eye referencing their job of looking and searching. The breacher is symbolized by a door (rectangle) over the shaft as the breacher's job is to create an entry portal for team members to access rooms. The medic is symbolized by a cross on the shaft. The psychological operations/hostage negotiator is symbolized by a loud speaker with sound emanating from the bell over the shaft. The less lethal or non lethal weapons operator is symbolized by the null set symbol which is a zero with a line through it at an angle over the shaft to symbolize the importance of the weapon.

The communications operator is symbolized by a lightning bolt on the shaft which symbolizes the electrical current that charges communications systems. The explosives ordnance disposal (EOM technician is symbolized by a lateral line representing a fuse with a break and an “X” representing the disruption blast that broke the fuse/firing train. The engineer is symbolized by the shovel superimposed over the arrow shaft which represents the engineer's job of digging field works and construction. The canine handler is represented by the dog's paw superimposed over the shaft. The police patrol officer/military policeman is represented by a set of hand cuffs superimposed over the shaft. The alternate sniper symbol consists of a circle with cross forming a scope reticle. The vehicle driver is symbolized by a wheel (steering, pilot, or road wheel). The HAZMAT/NBC operator is symbolized by the gas mask (face mask, lens, and filter) superimposed over the shaft. The maintenance operator is represented by a wrench over the shaft. The supply or quartermaster technician is represented by the key to the supply container superimposed over the shaft. The aviator is symbolized by wings superimposed over the shaft. The mariner/diver is symbolized by an anchor superimposed over the shaft.

Regarding non-combatant symbols, media is represented by an old style motion picture camera on tripod. A dead person is represented by a headstone on ground. A wounded person is represented by a medical cross over ground. A person (non-combatant) and or potential enemy combatant is represented by a stick figure human. A paramedic is represented by the caduceus. A fireman is represented by the fireman's axe.

With further reference to FIG. 1, the tactical mission planning set includes magnetic tiles 10-78 having symbols printed thereon. In various implementations, the magnetic tiles 10-78 can be placed on a sand table, on a markable board for use with erasable markers, or other suitable means. Additionally, blank tiles may be provided to selectively form additional units (e.g., using a pen or pencil). Such additional symbols may be duplicates of other units or may be units that were not included in the tactical mission planning set. As set forth above, the simplicity of the symbols allows them to be easily taught and understood such that all parties involved in an operation know where they are supposed to be as well as those who will be around them.

In some embodiments, a universal set of symbols may be created and approved as doctrine for use when writing by hand. Such symbols are preferably designed to be simple to allow for quick drawing with the fewest brush strokes. The symbols could be used with permanent or non-permanent markers on multiple mediums. In addition, the symbols could be used in literature to diagram historic movements of an event. Example may include, but are not limited to, charts, books, and manuals. Furthermore, digital use could include mapping software such as Google Earth or Falcon View mapping software where the symbols may be employed as icons or avatars to represent personnel or weapons systems. Such symbols may be dragged and dropped over images of maps or satellite imagery.

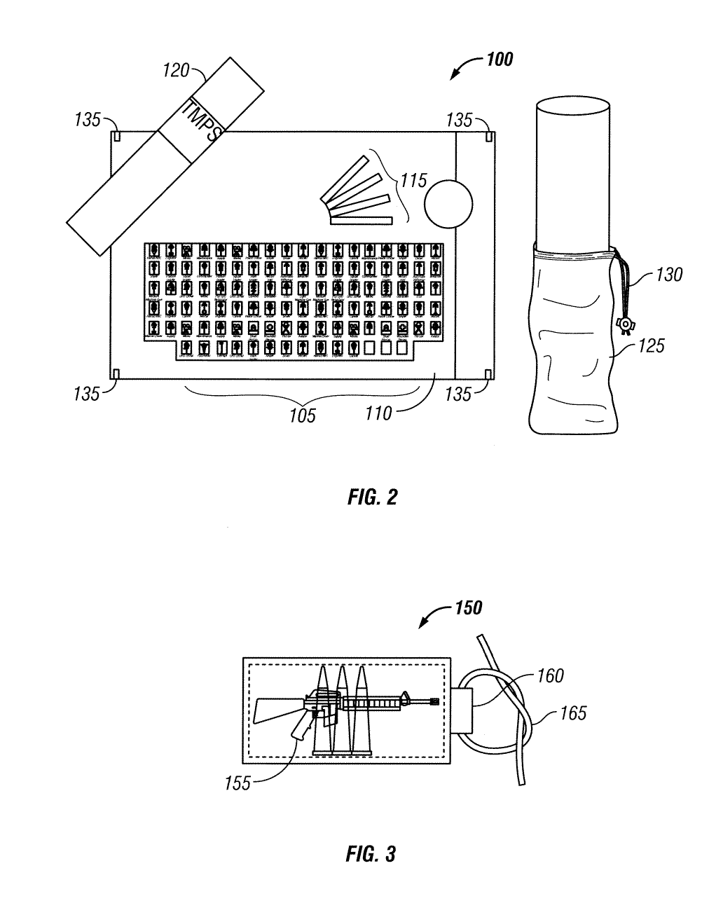

Referring to FIG. 2, a tactical mission planning kit 100 is illustrated comprising a tile set 105 (such as that of FIG. 1), as well as a board 110, a set of markers 115, a compact carrying case 120, and a carrying bag 125. In some embodiments, the board 110 comprises a flexible magnetic dry erase board and the markers 115 comprise dry erase markers. Since the tiles 105 and board 110 are easily carried and utilized, they are physically easy to use in training operations, after action reviews, and in the field. The flexible board 110 may be rolled up and inserted into the carrying case 120 along with the tiles 105 and markers 115 such that the entire kit 100 may be easily transported. The carrying bag 125 may comprise a convenient, compact, light weight, easy to carry pouch with closure device 130 such as a cinch tie.

According to various embodiments of the invention, the flexible magnetic dry erase board 110 can be used to simulate a tactical mission by employing the magnetic tiles 105 and markings as tactical symbols. According to further embodiments, a tactical leader such as a commander may carry a small handful of tiles 105 in a pocket to be utilized without the flexible magnetic dry erase board, e.g., on a sand table on the ground, which adds to the user friendliness and portability of the system. Such a system is a vast improvement over the use of rocks and sticks to simulate individuals and their positions. In some embodiments, the tiles 105 and the magnetized board 110 are provided in a subdued or camouflaged color for use in tactical environments.

With further reference to FIG. 2, the flexible magnetic dry erase board 110 can be hung by it's grommets 135 or laid out on the ground, on a table, on a car hood, etc. The dry erase markers 115 can be used to draw building layouts, terrain, and movements. By way of example, red and blue markers can designate friend or foe. In addition, simple slashes or codes or initials can be employed. In some embodiments, magnet symbols can be drawn on with erasable markers, and the magnetic tiles 105 can then be used on a sand table or larger magnetic board. The use of the magnetic tiles 105 on the flexible magnetized board 110 allows for quick changes to adapt to changes in tactical planning.

In one embodiment of the invention, various apparel including, but not limited to, patches, hats, t-shirts, and IR patches may be produced incorporating the above-described symbology. FIG. 3 depicts an example patch 150 including a symbol 155 and a tab 160 that can receive a cord 165, thereby creating an identifier tag for a gear bag or other item. In patch form, the symbol 155 can be embroidered, layer cut, silk screened or similarly printed on a container to denote the contents of the vessel. When attached to a uniform, the patch 150 may denote the skill possessed or the equipment carried by the person. In some embodiments, a patch may comprise infrared technology for low light or no light marking.

In the illustrated embodiment, the symbol 155 is sewed onto the patch 150. In addition, a tab 160 having, for example, a person's name or “Made in the USA,” may be formed into a loop and attached to the patch 150, thus enabling the symbology patch 150 used as a gear identifier to be employed in multiple methods of attachment. In one example, hook and loop fasteners may be used to attach the patch 150 to the person's gear. In embodiments that do not feature hook and loop fasteners, cord 165 (e.g., 550 parachute cord) is passed through the tab 160 and tied into a loop, which can then be tied to a gear bag for proper identification of the gear which it contains.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to impart the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A tactical mission planning kit, comprising:
a tile set including a plurality of tiles;
a board for placement of the tiles;
a set of markers for drawing on the board; and
a compact carrying case comprising a housing for the tile set, board and set of markers.

2. The tactical mission planning set of claim 1, wherein the tiles comprise magnetic tiles, the board comprises a flexible magnetized dry erase board, and the markers comprise dry erase markers.

3. The tactical mission planning set of claim 1, wherein the flexible board is configured to be rolled up and inserted into the carrying case along with the tiles and markers.

4. The tactical mission planning set of claim 1, further comprising a carrying bag for holding and facilitating the transport of the compact carrying case.

5. The tactical mission planning set of claim 2, wherein the flexible magnetized dry erase board is used to simulate a tactical mission by employing the magnetic tiles as tactical symbols.

6. The tactical mission planning set of claim 1, wherein the tiles and the board are provided in a subdued or camouflaged color for use in tactical environments.

7. The tactical mission planning set of claim 1, wherein each tile is marked with one or more symbols.

8. The tactical mission planning set of claim 7, wherein the symbols designate friendly and enemy personnel according to equipment they carry and mission role.

9. The tactical mission planning set of claim 7, wherein the symbols are based on an arrow symbol that iconizes a standard automatic rifle bearer.

10. The tactical mission planning set of claim 1, wherein the plurality of tiles includes tiles representing a commander, a platoon leader, a squad leader, a team leader, a reconnaissance/intelligence operator, an automatic rifleman, a breacher, a sniper, a medic, a psychological operations operator/hostage negotiator, a grenadier, explosive ordnance disposal (EOM technician, a light machine gun, a medium machine gun, and a mortar.

11. The tactical mission planning set of claim 1, wherein the plurality of tiles includes tiles representing an engineer, a canine handler, a police officer, a sniper, a driver, a rocket, hazmat/NBC, maintenance, supply, an aviator, a mariner/diver, media, a dead person, a wounded person, a person, a paramedic, and a fireman.

12. The tactical mission planning set of claim 1, wherein each tile is marked with one or more symbols based upon a universal set of symbols designed to be simple to allow for quick drawing with the fewest brush strokes.

13. A system, comprising:
a tactical mission tile set including a plurality of tiles, wherein each tile is marked with one or more symbols;
a board for placement of the tiles; and
a set of markers for drawing on the board.

14. The system of claim 13, further comprising a compact carrying case comprising a housing for the tile set, board and set of markers.

15. The system of claim 13, wherein the tiles comprise magnetic tiles, the board comprises a flexible magnetic dry erase board, and the markers comprise dry erase markers.

16. The system of claim 13, wherein the flexible board is configured to be rolled up and inserted into the carrying case along with the tiles and markers.

17. The system of claim 13, further comprising a carrying bag for holding and facilitating the transport of the compact carrying case.

18. The system of claim 13, wherein the symbols designate friendly and enemy personnel according to equipment they carry and mission role.

19. The system of claim 13, wherein the plurality of tiles includes tiles representing a commander, a platoon leader, a squad leader, team leader, reconnaissance/intelligence operator, an automatic rifleman, a breacher, a sniper, a medic, a psychological operations operator/hostage negotiator, a grenadier, explosive ordnance disposal (EOD), a light machine gun, a medium machine gun, and a mortar.

20. The system of claim 13, wherein the plurality of tiles includes tiles representing an engineer, a canine handler, a police officer, a sniper, a driver, a rocket, hazmat/NBC, maintenance, supply, media, a dead person, a wounded person, a person, an aviator, a marine/diver, a paramedic, a fireman.

21. The system of claim 20, wherein the plurality of tiles further includes one or more blank tiles for selectively adding units.

22. A system, comprising:
a tactical mission scheme based upon a plurality of symbols that designate friendly and enemy personnel according to equipment they carry and mission role;
wherein the tactical mission scheme includes symbols representing a commander, a platoon leader, a squad leader, team leader, reconnaissance/intelligence operator, an automatic rifleman, a breacher, a sniper, a medic, a psychological operations operator/hostage negotiator, a grenadier, explosive ordnance disposal (EOD), a light machine gun, a medium machine gun, and a mortar.
